(19) United States
(12) Patent Application Publication
(10) Pub. No.: US 2026/0019126 A1
(43) Pub. Date: Jan. 15, 2026

(54) COMMUNICATION DEVICE AND METHOD FOR REPORTING OF GROUPED GROUND TRUTHS FOR ARTIFICIAL INTELLIGENCE/MACHINE LEARNING

(71) Applicant: SHENZHEN TCL NEW TECHNOLOGY CO., LTD., Shenzhen, Guangdong (CN)

(72) Inventor: Junrong GU, Shenzhen, Guangdong (CN)

(73) Assignee: SHENZHEN TCL NEW TECHNOLOGY CO., LTD., Shenzhen, Guangdong (CN)

(21) Appl. No.: 18/995,160

(22) PCT Filed: Aug. 12, 2022
(86) PCT No.: PCT/CN2022/112252

§ 371 Date: Jan. 16, 2025

(51) Int. Cl. H04B 7/06; H04L 41/16; H04W 24/10

(52) U.S. Cl. CPC H04B 7/0626; H04L 41/16; H04W 24/10

(57) ABSTRACT

Communication devices and methods for reporting of grouped ground truths for artificial intelligence (AI)/machine learning (ML) are disclosed. The method for reporting of grouped ground truths for AI/ML performed by a user equipment (UE) includes determining, by the UE, channel state information reference signal (CSI-RS) measurement occasions to collect ground truths for generating grouped ground truth report for an AI/ML and reporting, to a base station, the grouped ground truths for the AI/ML in a periodic manner, a semi-persistent manner, and/or an aperiodic manner on an uplink channel.

### BACKGROUND OF DISCLOSURE

### 1. Field of the Disclosure

The present disclosure relates to the field of wireless communication systems, and more particularly, to communication devices and methods for group reporting of ground truth for artificial intelligence (AI)/machine learning (ML), for example, the present disclosure is related to the new study item description (SID) on AI/ML for new radio (NR) air interface of the Release 18, which is established in 3rd generation partnership project (3GPP) radio access network (RAN) plenary meetings 94e in December 2022. Particularly, the present disclosure is related to an enhanced channel state information (CSI) report feedback, beam management and positioning, wherein during data collection and model monitoring, the ground truth is reported to a base station such as a gNB by a UE.

### 2. Description of the Related Art

The AI/ML is applied to the 3GPP RAN1. Several use cases are decided to be studied. They are respectively a CSI feedback enhancement, a beam management, and a positioning. As indicated in the 3GPP new SID, although specific AI/ML algorithms and models may be studied for evaluation purposes, AI/ML algorithms and models are implementation specific and are not expected to be specified. Currently, group reporting is supported in RAN1 in layer 1 reference signal received power (L1-RSRP) reporting. However, it is not for ground truth reporting. Further, the report of ground truth to a gNB from a UE costs a lot of resources and signalings, and cause scheduling overhead. Furthermore, the quantization of the ground truth needs to be studied.

Therefore, there is a need for communication devices and methods for group reporting of ground truth for artificial intelligence (AI)/machine learning (ML), which can solve the issues in the prior art, savean overhead of a reporting ground truth to a gNB from a UE, reduce the size of a reporting content with a new quantization method, reduce system overhead, provide a good communication performance, and/or provide high reliability.

### SUMMARY

An object of the present disclosure is to propose communication devices and methods for group reporting of ground truth for artificial intelligence (AI)/machine learning (ML), which can solve the issues in the prior art, save an overhead of a reporting ground truth to a gNB from a UE, reduce the size of a reporting content with a new quantization method, reduce system overhead, provide a good communication performance, and/or provide high reliability.

In a first aspect of the present disclosure, a method for reporting of grouped ground truths for artificial intelligence (AI)/machine learning (ML) performed by a user equipment (UE) includes determining, by the UE, channel state information reference signal (CSI-RS) measurement occasions for generating a grouped ground truth report for an AI/ML and reporting, to a base station, the grouped ground truths for the AI/ML in a periodic manner, a semi-persistent manner, and/or an aperiodic manner on an uplink channel.

In a second aspect of the present disclosure, a user equipment (UE) comprises a memory, a transceiver, and a processor coupled to the memory and the transceiver. The processor is configured to execute the above method.

In a third aspect of the present disclosure, a method for reporting of grouped ground truths for artificial intelligence (AI)/machine learning (ML) performed by a base station includes configuring, to a UE, CSI-RS measurement occasions for the UE to generate a report of grouped ground truths for an AI/ML and controlling the UE to report the grouped ground truths for the AI/ML in a periodic manner, a semi-persistent manner, and/or an aperiodic manner on an uplink channel.

In a fourth aspect of the present disclosure, a base station comprises a memory, a transceiver, and a processor coupled to the memory and the transceiver. The processor is configured to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a basic auto-encoder model for enhanced CSI feedback according to an embodiment of the present disclosure.

FIG. 2 is a block diagram of one or more user equipments (UEs) and a base station (e.g., gNB) of communication in a communication network system according to an embodiment of the present disclosure.

FIG. 3 is a flowchart illustrating a wireless communication for group reporting of ground truth for artificial intelligence (AI)/machine learning (ML) performed by a UE according to an embodiment of the present disclosure.

FIG. 4 is a flowchart illustrating a wireless communication for group reporting of ground truth for artificial intelligence (AI)/machine learning (ML) performed by a base station according to an embodiment of the present disclosure.

FIG. 5 is a schematic diagram illustrating an example of a basic auto-encoder model for enhanced CSI feedback according to an embodiment of the present disclosure.

FIG. 6 is a schematic diagram illustrating an example of an independent quantization of each entry according to an embodiment of the present disclosure.

FIG. 7 is a schematic diagram illustrating an example of the differential quantization across each entry according to an embodiment of the present disclosure.

FIG. 8 is a schematic diagram illustrating an example of the difference between vector v2 and v1 according to an embodiment of the present disclosure.

FIG. 9 is a schematic diagram illustrating an example of an adaptive grouped reporting according to an embodiment of the present disclosure.

FIG. 10 is a flowchart illustrating an example of a configuration grouped reporting according to an embodiment of the present disclosure.

FIG. 11 is a schematic diagram illustrating an example that a vector v_{(n/2)} is selected as the reference vector according to an embodiment of the present disclosure.

FIG. 12 is a schematic diagram illustrating an example of CSI measurement occasions right after the indication of the grouped ground truths report are selected for grouped reporting according to an embodiment of the present disclosure.

FIG. 13 is a schematic diagram illustrating an example of CSI measurement occasions right after the indication of grouped ground truth report and the processing delay are selected for grouped reporting according to an embodiment of the present disclosure.

FIG. 14 is a schematic diagram illustrating an example of CSI measurement occasions right before the grouped ground truth reporting occasion and the processing delay are selected for grouped reporting according to an embodiment of the present disclosure.

FIG. 15 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The AI/ML is introduced into a physical (PHY) layer and a medium access control (MAC) layer, to enhance the system performance. Several use cases are decided to be studied in 3GPP RAN1. They are respectively the CSI feedback compression, the beam management, and the positioning. The ML learning models can be trained either online or offline.

For a machine learning model, the ground truth data is needed for model training, either online training or offline training, and model monitoring. Usually, the ground truth data is reported to a gNB from a UE with high precisions. In order to retain fidelity of ground truth and reflecting the true features, the ground truth should be reported with high precision. That would cost a lot of resources and signalings, plus the scheduling overhead. It would burden the UE from proper working. Thus, the ground truth reporting overhead should be reduced. A natural way is to buffer or keep the collected ground truth at UE and report them in a batch/group manner. The report of ground truth to the gNB from the UE costs a lot of resources and signalings, and cause scheduling overhead. The ground truths can be put into a batch/group and reported less frequently. Furthermore, the quantization of the ground truth should be studied. On one hand, the quantization should be high precision, which needs more bits. On the other hand, the overall size of the reporting content should be reduced.

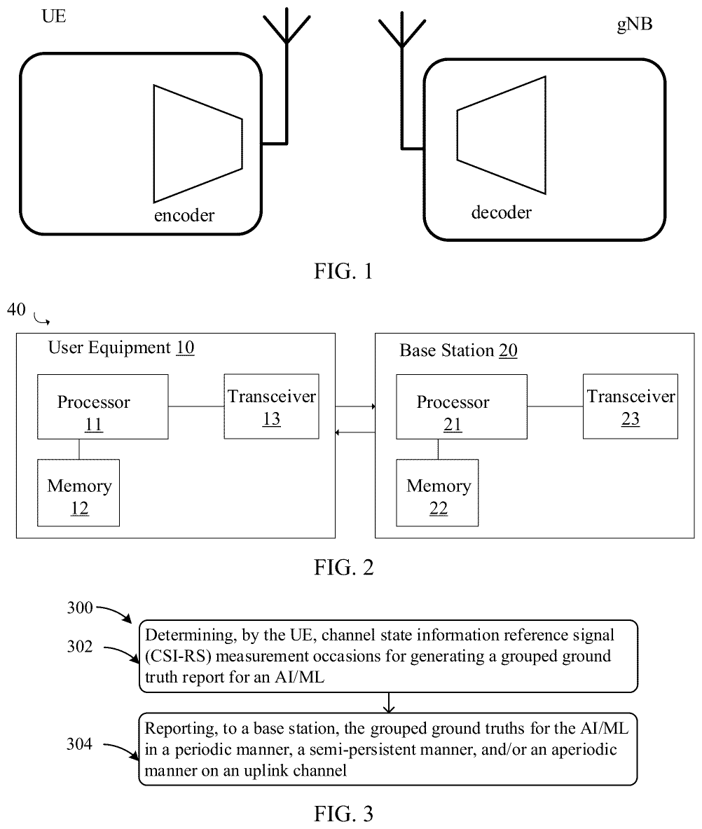

Some embodiments of the present disclosure discuss the CSI feedback enhancement case. FIG. 1 is a schematic diagram illustrating an example of a basic auto-encoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

FIG. 2 illustrates that, in some embodiments, one or more user equipments (UEs) 10 and a base station (e.g., gNB) 20 for communication in a communication network system 40 according to an embodiment of the present disclosure are provided. The communication network system 40 includes the one or more UEs 10 and the base station 20 (such as a first base station or a second base station). The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to determine channel state information reference signal (CSI-RS) occasions for reporting grouped ground truths for an AI/ML and the transceiver 13 is configured to report to the base station 20, the grouped ground truths for the AI/ML in a periodic manner, a semi-persistent manner, and/or an aperiodic manner on an uplink channel. This can solve the issues in the prior art, save an overhead of a reporting ground truth to a gNB from a UE, reduce the size of a reporting content with a new quantization method, reduce system overhead, provide a good communication performance, and/or provide high reliability.

In some embodiments, the processor 21 is configured to configure, to the UE 10, CSI-RS occasions for the UE 10 to report grouped ground truths for an AI/ML, and the processor 21 is configured to control the UE 10 to report the grouped ground truths for the AI/ML in a periodic manner, a semi-persistent manner, and/or an aperiodic manner on an uplink channel. This can solve the issues in the prior art, save an overhead of a reporting ground truth to a gNB from a UE, reduce the size of a reporting content with a new quantization method, reduce system overhead, provide a good communication performance, and/or provide high reliability.

FIG. 3 illustrates a wireless communication method 300 for group reporting of ground truth for artificial intelligence (AI)/machine learning (ML) performed by a UE according to an embodiment of the present disclosure. In some embodiments, the method 300 includes: a block 302, determining, by the UE, channel state information reference signal (CSI-RS) measurement occasions for generating a grouped ground truth report for an AI/ML, and a block 304, reporting, to a base station, the grouped ground truths for the AI/ML in a periodic manner, a semi-persistent manner, and/or an aperiodic manner on an uplink channel. This can solve the issues in the prior art, save an overhead of a reporting ground truth to a gNB from a UE, reduce the size of a reporting content with a new quantization method, reduce system overhead, provide a good communication performance, and/or provide high reliability.

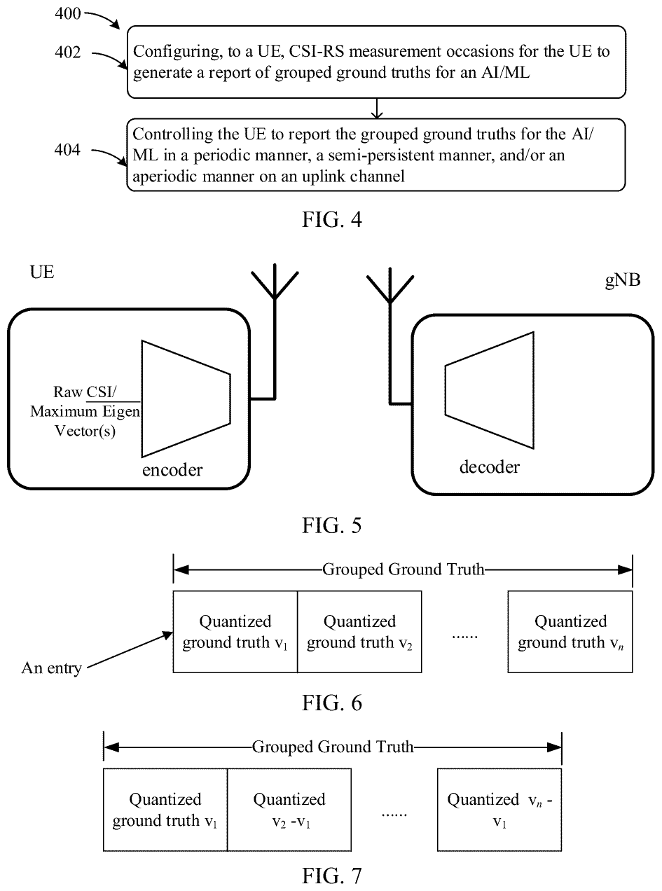

FIG. 4 illustrates a wireless communication method 400 for group reporting of ground truth for artificial intelligence (AI)/machine learning (ML) performed by a base station according to an embodiment of the present disclosure. In some embodiments, the method 400 includes: a block 402, configuring, to a UE, CSI-RS measurement occasions for the UE to generate a report of grouped ground truths for an AI/ML, and a block 404, controlling the UE to report the grouped ground truths for the AI/ML in a periodic manner, a semi-persistent manner, and/or an aperiodic manner on an uplink channel. This can solve the issues in the prior art, save an overhead of a reporting ground truth to a gNB from a UE, reduce the size of a reporting content with a new quantization method, reduce system overhead, provide a good communication performance, and/or provide high reliability.

In some embodiments, the grouped ground truths are used for at least one of enhanced CSI feedback, predictive beam management, and positioning. In some embodiments, the collection of grouped ground truths for the AI/ML is activated or deactivated by at least one of a radio resource configuration (RRC) signaling, a media access control-control element (MAC-CE), and a downlink control information (DCI). In some embodiments, the grouped ground truths for the AI/ML is pre-configured by the RRC signaling for a group size and activated by the MAC-CE or the DCI. In some embodiments, reporting, to the base station, the grouped ground truths for the AI/ML in the periodic manner, the semi-persistent manner, and/or the aperiodic manner on the uplink channel is associated with a UE capability.

In some embodiments, the uplink channel delivering the report of grouped ground truths comprises a physical uplink control channel (PUCCH) or a physical uplink shared channel (PUSCH). In some embodiments, the PUCCH comprises a PUCCH format 3 and/or a PUCCH format 4. In some embodiments, if the grouped ground truths for the AI/ML is not allowed to be transmitted on the PUCCH, the UE does not report the grouped ground truths on the PUCCH.

In some embodiments, the CSI measurement occasions to collect the ground truths after a grouped ground truth indication are selected to generate the grouped ground truth report for the AI/ML. In some embodiments, the CSI measurement occasions to collect the ground truths after grouped ground truths indication plus a UE processing delay are selected for reporting the grouped ground truths for the AI/ML. In some embodiments, there is a UE processing time before the reporting occasion of the grouped ground truths for the AI/ML. In some embodiments, the CSI measurement occasions are selected in a sparse manner for reporting the grouped ground truths for the AI/ML. For example, to collect the ground truths collected from the even/odd CSI measurement occasions are selected generate the grouped ground truth report.

In some embodiments, if no adequate ground truth entries are collected from the CSI measurement occasions for reporting the grouped ground truths for the AI/ML, the UE does not report the grouped ground truths for the AI/ML. In some embodiments, if no adequate ground truth entries are collected from the CSI measurement occasions for reporting the grouped ground truths for the AI/ML, the UE keeps the grouped ground truths for the AI/ML in a buffer and reports the grouped ground truths for the AI/ML at next reporting occasion until enough ground truth entries are collected. In some embodiments, a raw ground truth is in the form of a vector, multiple vectors used as multiple entries are packaged together to form the grouped ground truths, and the vectors in the grouped ground truths are quantized separately. In some embodiments, when the grouped ground truths for the AI/ML are used for enhanced CSI feedback, the grouped ground truths for the AI/ML are raw CSI-RS values or a maximum Eigen vector.

In some embodiments, when the grouped ground truths for the AI/ML is used for predictive beam management, the grouped ground truths for the AI/ML contain multiple measured layer 1-reference signal received power (L1-RSRP), and each reported L1-RSRP paired with a beam index or a location information forms each entry. In some embodiments, when the grouped ground truths for the AI/ML are used for positioning, the grouped ground truths for the AI/ML are a location information comprising [coordinate, RS], [(x, y), RS], or [Tag, RS], the tag is a mark/label of a reference node, such that each entry comprises an RS amplitude quantization and a phase quantization.

In some embodiments, a ground truth or a part of the ground truth is used as a vector, entries in the grouped ground truths for the AI/ML are quantized with a reference entry and quantized differentially. In some embodiments, when the grouped ground truths for the AI/ML are used for enhanced CSI feedback, the grouped ground truth for the AI/ML are raw CSI-RS values. In some embodiments, when the grouped ground truths for the AI/ML are used for predictive beam management, the grouped ground truths for the AI/ML are a measured layer 1-reference signal received power (L1-RSRP), each reported L1-RSRP paired with a beam index or a location information forms each entry, and each reported L1-RSRP paired with the beam index or the location information is quantized differentially according to a maximum L1-RSRP. In some embodiments, when the grouped ground truths for the AI/ML are used for positioning, the grouped ground truths for the AI/ML are position reference signals, in each entry, an element amplitude is quantized with a configured step value or a fixed step value and a phase with at least one of {8PSK, QPSK, BPSK}.

In some embodiments, after the grouped ground truths for the AI/ML are configured by the base station, if the UE supports the grouped ground truth report for the AI/ML in a UE capability, the UE reports the grouped ground truths for the AI/ML; or otherwise, if the UE does not support the grouped ground truth report for the AI/ML in the UE capability, the UE reports a single ground truth based for AI/ML in a reporting occasion. In some embodiments, the UE reporting a single ground truth for the AI/ML in one reporting occasion is a default configuration. In some embodiments, a first vector in time, last vector in time, a medium vector in time, a vector with a maximum Euclidean distance, a vector closest to a medium Euclidean distance value, or a vector indicated by the base station is used as reference vector in the grouped ground truths for the AI/ML.

In some embodiments, a number of entries in the grouped ground truths for the AI/ML is configured by the base station through the RRC signaling, the MAC-CE, or the DCI. In some embodiments, the UE reporting to the base station the grouped ground truths for the AI/ML, is bases on a UE capability.

FIG. 5 is a schematic diagram illustrating an example of a basic auto-encoder model for enhanced CSI feedback according to an embodiment of the present disclosure.

FIG. 5 illustrates that, in some embodiments, there are two kinds designs for the auto-encoder model, according to the input. The input is the raw CSI (raw CSI-RS values), and the input is the Eigen vector corresponding to the maximum Eigen value after channel matrix decomposition. Some embodiments term this Eigen vector as the maximum Eigen vector. Some examples may be added in the description for multiple CSIs sub use case with/without CSI prediction.

### EMBODIMENTS

### Embodiment 1

FIG. 6 is a schematic diagram illustrating an example of an independent quantization of each entry according to an embodiment of the present disclosure. FIG. 6 illustrates that, in some embodiments, the ground truth can be in the form of a vector e.g., v. In some examples, the vector v comprises several elements. As an example, the entries (vectors) in the grouped ground truths are quantized separately. Multiple entries are packaged together.

In some examples, for enhanced CSI feedback, the ground truth can be raw CSI-RS values or maximum Eigen vector. It can be treated as a complex vector and quantized. For example, for each vector, an element with maximum amplitude is chosen and the other element within this entry is quantized according to it. The amplitude and the phase of the element can be quantized separately. The making of one entry comprises the index of highest element, the indications (indexes) of non-zero elements, and the quantized amplitudes of non-zero elements according to the element with highest amplitude. Further, the quantized phases of these non-zero elements are provided.

In some examples, for predictive beam management, the ground truth can be measured L1-RSRP. Multiple measurements can be quantized as according the one with maximum L1-RSRP. The difference is that each reported L1-RSRP is paired with a beam index. The beam index can be the UE receiving beam indexes. Or the L1-RSRP is paired with location information. This L1-RSRP pair makes an entry.

In some examples, for positioning, the ground truth can be a location information e.g., [coordinate, RS], [(x, y), RS], or [Tag, RS], the tag is the mark/label of a reference node. The making of one entry comprises the RS amplitude quantization and phase quantization.

### Embodiment 2

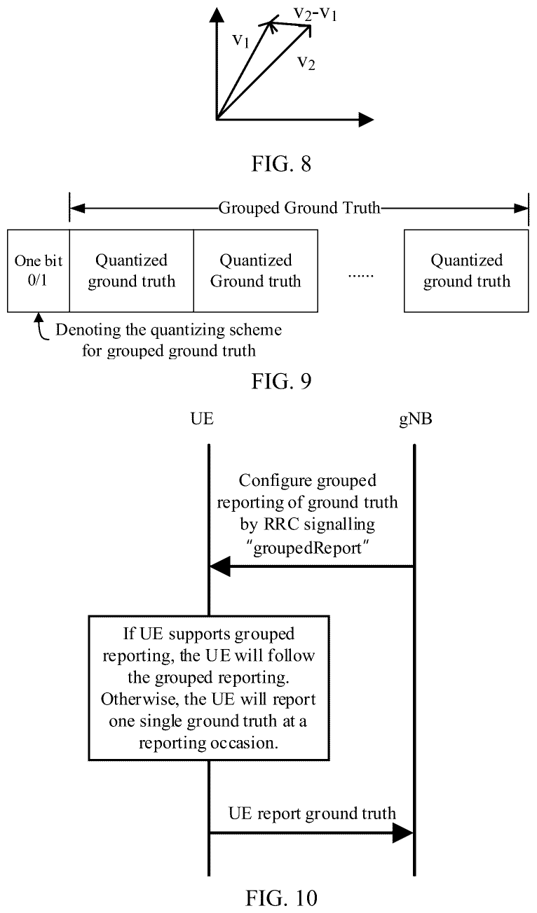

FIG. 7 is a schematic diagram illustrating an example of the differential quantization across each entry according to an embodiment of the present disclosure. FIG. 7 illustrates that, in some embodiments, if the ground truth or part of the ground truth can be described with a vector v. The entries in a grouped reporting can be quantized with a reference entry and quantized differentially. FIG. 8 is a schematic diagram illustrating an example of the difference between vector v2 and v1 according to an embodiment of the present disclosure. FIG. 8 illustrates that, in some embodiments, the quantization of vector v2-v1, vector v2-v1 is with a lower level or coarse quantization levels to save the quantization bits. For slow fading channels, the quantization of v2-v1 saves more bits than quantizing the v2 directly. The difference of vector v1 and v2 is shown in FIG. 8. It is a vector with smaller amplitude.

In some examples, the v1 is a complex vector. For enhanced CSI feedback, it is raw CSI-RS values (vectors). For positioning, it is position reference signals (RS). The element amplitude is quantized with 4 bits and phase with at least one of {8PSK, QPSK, BPSK}. For example, a range between 0 and maximum value is quantized by 4 bits and 16 levels. In addition, a bitmap indicating the non-zero amplitude elements, and v2−v1 is quantized with 2 bits and phase with at least one from {8PSK, QPSK, BPSK}.

In some examples, the quantization of the amplitude of an element in v2−v1 is following the table. “00” indicates the amplitude of an element in vector v2−v1 is the \sqrt{2}/2 of the corresponding elements in v1.\tilde{v}=v2−v1.

$$\tilde{v} = [ {v}_{1}^{12} , {v}_{2}^{12} , … , {v}_{m}^{12} ] ,$$

v₁=[v₁, v₂, . . . , vₘ]. If the amplitude of

$$\vert {v}_{2}^{12} \vert$$

can be quantized as \sqrt{2}/2|v₂| with “00”.

TABLE

| 00 | 01 | 10 | 11 |
|---|---|---|---|
| \sqrt{2}/2 | 1 | \sqrt{2} | 2 |

As an alternative, the quantization is taken with a fixed step value. For example, the different of the amplitude of

$$\vert {v}_{2}^{12} \vert$$

can be quantized as “00”, if the amplitude of

$$\vert {v}_{2}^{12} \vert$$

is less than one step (value) of |v₂|.

In some examples, for predictive beam management, the L1-RSRP in grouped reporting is quantized differentially according to a maximum L1-RSRP. The other information for example, the location, or the beam index in entry in still paired with the L1-RSRP. In this case, an entry is made up of two parts [beam index, L1-RSRP] or [location information, L1-RSRP].

### Adaptive Group Reporting:

Whether to adopt embodiment 1 of embodiment 2 is configured by a gNB. FIG. 9 is a schematic diagram illustrating an example of an adaptive grouped reporting according to an embodiment of the present disclosure. FIG. 9 illustrates that, in some embodiments, whether the grouped ground truth reporting adopts embodiment 1 of embodiment 2 is decided by UE. If the differences between two vectors becomes large, rendering the quantization granularity very coarse, the UE may choose the method in embodiment 1. As an example, the measurement here can be the Euclidean Distance if it is larger than a threshold, the UE may choose embodiment. Otherwise, the UE may choose the method in embodiment 2. The threshold is indicated by the gNB. Particularly, one bit in the grouped report may indicate the specific scheme UE adopted. For example, “0” indicates embodiment 1, and “1” indicates embodiment 2.

FIG. 10 is a flowchart illustrating an example of a configuration grouped reporting according to an embodiment of the present disclosure. FIG. 10 illustrates that, in some embodiments, after the gNB configures a grouped reporting of the ground truth, if the UE supports the grouped reporting in a UE capability, the UE may report the grouped ground truths. Otherwise, if the UE does not support the grouped reporting, the UE may report a single ground truth as a reporting occasion. In some examples, the UE may report one single ground truth in one reporting occasion, which is a default configuration. If the gNB does not configure any reporting method to the UE, the UE may report one single ground truth in one reporting occasion.

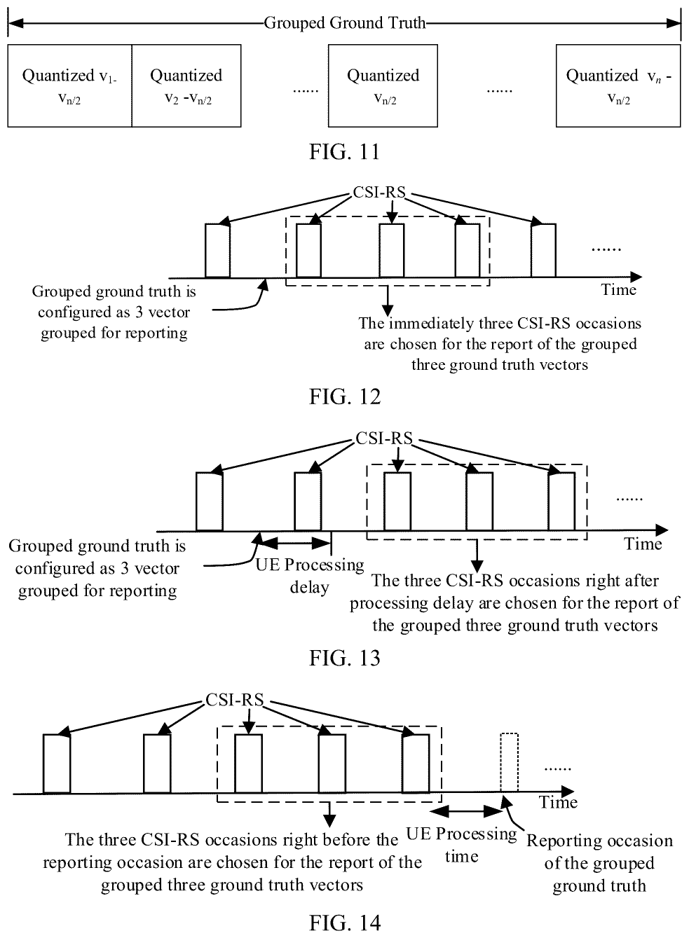

FIG. 11 is a schematic diagram illustrating an example that a vector v_{(n/2)} is selected as the reference vector according to an embodiment of the present disclosure. FIG. 11 illustrates that, in some examples, the first vector in time in the report of grouped ground truths is selected as the reference vector in a grouped reporting. In some examples, the last vector in time in the report of grouped ground truths is selected as the reference vector in a grouped reporting. In some examples, the medium one is selected as the reference vector. When n is an even number, the vector v_{n/2} is selected as the reference vector. When n is odd, the vector └₂ⁿ┘ is selected as the reference vector. In some examples, the reference vector is chosen as the one with maximum Euclidean distance. It is indicated to the gNB by a binary value, for example ‘01’ indicates the second vector/entry in the grouped report as the reference vector. In some examples, the vector is closest to the medium Euclidean distance value and is choose as the reference vector. In one example, the ground truth is raw CSI-RS values or the maximum Eigen vector. The quantization of each entry comprises two parts, the amplitude and phase. In some examples, the number of entries in a grouped ground truth report is configurable from gNB which is an RRC, DCI field, or MAC-CE signaling. In some examples, the reference vector in grouped reporting is indicated by the gNB, which is the RRC, DCI field, or MAC-CE signaling. In some examples, whether a UE can perform reporting grouped ground truths is a UE capability.

### Reporting the Grouped Ground Truths:

The grouped ground truth of enhanced CSI feedback by ML is defined as a kind of new report quantity/type. In some examples, it is an RRC signaling, a MAC-CE, or a DCI. The grouped ground truths of predictive beam management are defined as a kind of new report quantity/type. In some examples, it is an RRC signaling, a MAC-CE, or a DCI. The grouped ground truths of positioning based on AI/ML is defined as a kind of new report quantity/type. In some examples, it is an RRC signaling, a MAC-CE, or a DCI. In some examples, the reporting of grouped ground truths can be activated or deactivated by an RRC signaling, a MAC-CE, or a DCI. For example, it can be pre-configured with RRC for the group size and activated by a MAC-CE or a DCI. In one example, the grouped ground truth report is transmitted, in a periodic and/or semi persistent and/or aperiodic manner in PUSCH. In one example, the grouped ground truth report is transmitted, in a periodic and/or semi-persistent and/or aperiodic manner in PUCCH format 3 and/or PUCCH format 4. In one example, the grouped ground truth report is transmitted, in a periodic and/or semi-persistent and/or aperiodic manner in all PUCCH formats.

In some examples, the transmission of ground truth or the transmission of grouped ground truth (report) on PUCCH/or in at least one PUCCH format is a UE capability in a periodic and/or semi-persistent and/or aperiodic manner. For example, this capability is reported to a gNB by a UE. In one example, the report of grouped ground truths is not allowed to be transmitted on PUCCH. The UE does not transmit the grouped ground truth reporting on PUCCH.

### Determining the CSI Measurement Occasions for Collecting the Ground Truths:

FIG. 12 is a schematic diagram illustrating an example of determining the CSI measurement occasions for collecting the ground truths right after the grouped ground truth indication are selected for grouped reporting according to an embodiment of the present disclosure. These collected ground truths will be packaged and reported in group in one reporting occasion. FIG. 12 illustrates that, in some examples, the CSI-RS occasions right after the indication of the grouped ground truth report are chosen to collect the ground truths for the report of the grouped ground truth. An example is shown in FIG. 12, 3 CSI-RS measurement occasions are considered for collecting the ground truths, and the group size of the grouped ground truth is considered as 3.

FIG. 13 is a schematic diagram illustrating an example of determining the CSI measurement occasions for collecting the ground truths right after the grouped ground truth indication and the processing delay are selected for grouped reporting according to an embodiment of the present disclosure. FIG. 13 illustrates that, in some embodiments, when there is UE processing delay after the configuration of the grouped ground truth. The CSI-RS measurement occasions can be counted after this UE processing delay. As shown in FIG. 13, in some examples, the CSI-RS measurement occasions closely after the indication of the grouped ground truth report plus a UE processing delay are chosen for the report of the grouped ground truth. An example is shown in FIG. 13, 3 CSI-RS measurement occasions are considered for collecting the ground truths, and the group size of the grouped ground truth is considered as 3.

FIG. 14 is a schematic diagram illustrating an example of determining CSI measurement occasions for collecting the ground truths right before the grouped ground truth reporting occasion and the processing delay are selected for grouped reporting according to an embodiment of the present disclosure. FIG. 14 illustrates that, in some examples, the CSI measurement occasions are chosen in a sparse manner. For example, the even/odd CSI measurement occasions are selected for collecting the ground truths to generate the grouped ground truth report. When there is another kind of UE processing time before the reporting occasion of the grouped ground truth, the CSI-RS measurement occasions can be counted after this UE processing delay. As shown in FIG. 14, in some examples, the CSI-RS measurement occasions closely before the indication of the grouped ground truth report and a UE processing delay are chosen for the report of the grouped ground truth. An example is shown in FIG. 14, 3 CSI-RS measurement occasions are considered for collecting the ground truths, and the group size of the grouped ground truth is considered as 3.

In some examples, if no adequate ground truth entry is collected at the report occasion of the group ground truths, the grouped ground truths may not be reported at this report occasion. In some examples, if no adequate ground truth entries are collected at the report occasion of the group ground truths, the grouped ground truth will be kept in a buffer and reported at immediate next report occasion until enough ground truth entries are collected.

In summary, in some embodiments of this disclosure, a grouping method for the ground truth reporting is provided. It is understood that, for machine learning, the ground truth is needed for model training or model monitoring. The frequent reporting of the ground truth may cost a lot of resources and signalings. It is big overhead. To reduce this overhead, it is proposed that the ground truth is reported in a group. For example, it is proposed that the ground truth is reported in a group for enhance CSI feedback, predictive beam management, and/or positioning. In details, the method for reporting of grouped ground truths for AI/ML performed by a user equipment (UE) includes determining, by the UE, channel state information reference signal (CSI-RS) measurement occasions for collecting ground truths to generate a grouped ground truth for an AI/ML and report, to a base station, the grouped ground truth for the AI/ML in a periodic manner, a semi-persistent manner, and/or an aperiodic manner on an uplink channel. Some embodiments of this disclosure have at least one of invention effects: 1. The overhead of reporting ground truth to a gNB from a UE can be saved. 2. The size of the reporting content can be reduced with the new quantization method.

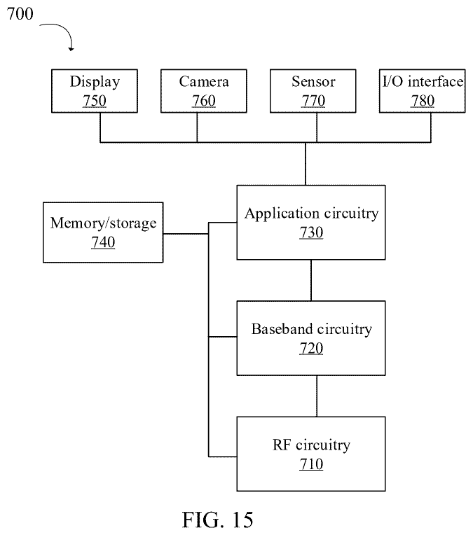

FIG. 15 is a block diagram of an example system 700 for wireless communication according to an embodiment of the present disclosure. Embodiments described herein may be implemented into the system using any suitably configured hardware and/or software. FIG. 15 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The reporting of grouped ground truths is not limited to the report from a UE to a gNB. In one example, the gNB can send, to the UE, the grouped ground truths via a downlink channel, e.g., PDSCH. In this case, the configuration or enabling of sending grouped report is an RRC signaling, a MAC-CE, or a DCI. In another example, the gNB or the UE sends the grouped ground truths to a third node. The grouped ground truths contained in the reporting can be organized with any quantization method and/or any CSI measurement occasion selection method in this disclosure. In this way, the signaling overhead is reduced between the sending node and the receiving node.

In some examples, the gNB or the UE may be the sending node, and the third node may be the receiving node.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for reporting of grouped ground truths for artificial intelligence (AI)/machine learning (ML) performed by a user equipment (UE), comprising:
determining, by the UE, channel state information reference signal (CSI-RS) measurement occasions for generating a grouped ground truth report for an AI/ML; and
reporting, to a base station, the grouped ground truths for the AI/ML in a periodic manner, a semi-persistent manner, and/or an aperiodic manner on an uplink channel.

2. The method according to claim 1, wherein the grouped ground truths are used for at least one of enhanced CSI feedback, predictive beam management, and positioning.

3. The method according to claim 1, wherein the collection of grouped ground truths for the AI/ML are activated or deactivated by at least one of a radio resource configuration (RRC) signaling, a media access control-control element (MAC-CE), and a downlink control information (DCI).

4. The method according to claim 3, wherein the grouped ground truths for the AI/ML are pre-configured by the RRC signaling for a group size and activated by the MAC-CE or the DCI.

5. The method according to claim 1, wherein reporting, to the base station, the grouped ground truths for the AI/ML in the periodic manner, the semi-persistent manner, and/or the aperiodic manner on the uplink channel are associated with a UE capability.

6. The method according to claim 1, wherein the uplink channel comprises a physical uplink control channel (PUCCH) or a physical uplink shared channel (PUSCH).

7. The method according to claim 6, wherein the PUCCH comprises a PUCCH format 3 and/or a PUCCH format 4.

8. The method according to claim 6, wherein if the grouped ground truths for the AI/ML are not allowed to be transmitted on the PUCCH, the UE does not report the grouped ground truths on the PUCCH.

9. The method according to claim 1, wherein the CSI measurement occasions after a grouped ground truth indication are selected for reporting the grouped ground truths for the AI/ML.

10. The method according to claim 1, wherein the CSI measurement occasions after a grouped ground truth indication plus a UE processing delay are selected for generating and reporting the grouped ground truths for the AI/ML.

11. The method according to claim 9, wherein there is a UE processing time before reporting the CSI measurement occasions for reporting the grouped ground truths for the AI/ML.

12. The method according to claim 9, wherein the CSI measurement occasions are selected in a sparse manner for reporting the grouped ground truths for the AI/ML.

13. The method according to claim 1, wherein if no adequate ground truth entries are collected reporting the CSI measurement occasions for reporting the grouped ground truths for the AI/ML, the UE does not report the grouped ground truths for the AI/ML at the CSI measurement occasions.

14. The method according to claim 1, wherein if no adequate ground truth entries are collected reporting the CSI measurement occasions for reporting the grouped ground truths for the AI/ML, the UE keeps the grouped ground truths for the AI/ML in a buffer and reports the grouped ground truths for the AI/ML at next reporting occasion until enough ground truth entries are collected.

15. The method according to claim 2, wherein a ground truth is in the form of a vector, multiple vectors used as multiple entries are packaged together to form the grouped ground truths, and the vectors in the grouped ground truths are quantized separately.

16-18. (canceled)

19. The method according to claim 2, wherein a ground truth or a part of the ground truth is used as a vector, entries in the grouped ground truths for the AI/ML are quantized with a reference entry and quantized differentially.

20-22. (canceled)

23. The method according to claim 1, wherein after the grouped ground truths for the AI/ML is configured by the base station, if the UE supports the grouped ground truths for the AI/ML in a UE capability, the UE reports the grouped ground truths for the AI/ML; or otherwise, if the UE does not support the grouped ground truths for the AI/ML in the UE capability, the UE reports a single ground truth based for AI/ML in a reporting occasion.

24. The method according to claim 1, wherein the UE reporting a single ground truth for the AI/ML in one reporting occasion is a default configuration.

25-26. (canceled)

27. The method according to claim 1, wherein the UE reporting to the base station, the grouped ground truths for the AI/ML are based on a UE capability.

28. A method for reporting of grouped ground truths for AI/ML performed by a base station, comprising:
configuring, to a UE, CSI-RS measurement occasions for the UE to generate a report of grouped ground truths for an AI/ML; and
controlling the UE to report the grouped ground truths for the AI/ML in a periodic manner, a semi-persistent manner, and/or an aperiodic manner on an uplink channel.
